(19) United States
(12) Patent Application Publication
(10) Pub. No.: US 2012/0032934 A1
(43) Pub. Date: Feb. 9, 2012

(54) METHOD AND DEVICE FOR DRIVING A BISTABLE NEMATIC DOT-MATRIX LIQUID CRYSTAL DISPLAY PANEL

(76) Inventors: Masafumi Hoshino, Chiba (JP); Shinichi Nogawa, Chiba (JP); Hisayuki Hirayama, Chiba (JP)

(21) Appl. No.: 13/138,718

(22) PCT Filed: Apr. 27, 2010
(86) PCT No.: PCT/JP2010/057481

§ 371 Date: Oct. 21, 2011

(30) Foreign Application Priority Data
May 29, 2009 (JP) 2009-131362

(51) Int. Cl. G09G 3/36; G02F 1/137; G06F 3/038

(52) U.S. Cl. 345/208; 349/37; 345/94

(57) ABSTRACT

Voltage consumption during flashing of a frame is suppressed. Under a state in which an image is written and held, when a waveform of low voltage at low frequency is applied to the whole surface of a bistable liquid crystal display panel, the liquid crystal molecules are inclined to some extent, if not to the state vertical to a substrate, and the frame displays gray close to white. After that, when the voltage application is stopped, the image displayed before the application appears because the orientation state of the bistable liquid crystal display panel is not broken. By utilizing this phenomenon, a state of applying the waveform of low voltage at low frequency and a non-application state are repeated at a given time interval, and hence the frame can be flashed with low power consumption.

### TECHNICAL FIELD

The present invention relates to a method and a device for driving a bistable liquid crystal display panel, and more particularly, to a method and a device for driving a dot matrix display panel using bistable nematic liquid crystal.

### BACKGROUND ART

FIG. 1 is a general functional block diagram for controlling display of a bistable liquid crystal display panel 10 having two stable states. The bistable liquid crystal display panel 10 is driven by a driving device including a common driving section (COM-IC) 11 for driving common lines in the horizontal direction, a segment driving section (SEG-IC) 12 for driving segment lines in the vertical direction, a power supply circuit 13 for generating drive potentials (V0, V12, V34, V5, and VCX), and a control section (MPU) 14 for controlling the common driving section 11, the segment driving section 12, and the power supply circuit 13.

Signals and functions of the control section 14 for controlling the common driving section 11 and the segment driving section 12 are the same as those in a normal STN driver circuit. For the common driving section 11, there are prepared an initialization signal RESETX, COM-Data for determining scan timing, a writing clock CL, an alternating current signal FRCOM, and DispOffx for display erasing. For the segment driving section 12, there are prepared the initialization signal RESETX, S-Data (DIO(8)) for providing display image data, a writing clock XCK, an alternating current signal FRSEG, and DispOffx for display erasing.

FIG. 2 is an explanatory diagram of switching between the states of bistable nematic liquid crystal, illustrating how to switch the twist direction of nematic liquid crystal molecules to two kinds of states, called twisted state (Twisted) and uniform state (Uniform), by applying specific signals to commons and segments of the bistable liquid crystal display panel.

Note that, in the drawings attached to this application, COM represents a common signal applied to a common electrode, COM-Scan represents a common signal at the time of selection, that is, a selection signal, COM-No Scan represents a common signal at the time of non-selection, that is, a non-selection signal, SEG represents a segment signal applied to a segment electrode, and COM-SEG represents a common-segment voltage, that is, a display voltage applied to an intersection pixel sandwiched by the common electrode and the segment electrode. Then, the above-mentioned write signal is divided into two kinds of signals, a white write signal and a black write signal, and the above-mentioned display signal is divided into two kinds of voltages, a white display voltage and a black display voltage.

In the beginning, the case of displaying white (White) at an intersection pixel between the common electrode and the segment electrode of the bistable liquid crystal display panel is described. As illustrated in part (a) of FIG. 2, the voltage waveform of the selection signal applied to the common terminal is a waveform which has the level of 0 for a first time interval “a” of a selection period T, a negative level −V for time intervals “b” and “c”, a positive level +V for subsequent time intervals “d” and “e”, a positive level +V−v for a subsequent time interval “f”, and the level of 0 for a subsequent time interval “g”.

As illustrated in part (b) of FIG. 2, the voltage waveform of the white write signal applied to the segment terminal is a waveform which has the level of 0 for the first time interval “a” to the time interval “e” of the selection period T, a negative level −v for the subsequent time interval “f”, and the level of 0 for the remaining time interval “g”.

When such time-varying selection signal and time-varying white write signal as described above are applied, the waveform of the white display voltage, which is a voltage difference between the common terminal and the segment terminal, becomes a time-varying waveform. That is, as illustrated in part (c) of FIG. 2, the waveform of the white display voltage is a waveform which has the level of 0 for the first time interval “a” of the selection period T, the negative level -V for the subsequent time intervals “b” and “c”, the positive level +V for the subsequent time intervals “d” to “f”, and the level of 0 for the remaining time interval “g”. This way, the waveform of the white display voltage shows a voltage transition between the negative level −V and the positive level +V.

The reason why the white display voltage having such waveform as described above is applied to the nematic liquid crystal is as follows. First, a stable state of orientation of nematic liquid crystal molecules is broken by the voltage having the negative level -V to raise the nematic liquid crystal molecules in the longitudinal direction (see part (g) of FIG. 2). After that, the voltage having the positive level +V is released to the voltage having the level of 0 to lay the nematic liquid crystal molecules in an alignment direction (see part (h) of FIG. 2), to thereby set the twisted state (Twisted). This way, the intersection pixel of the bistable liquid crystal display panel applied with the white display voltage having the waveform illustrated in part (c) of FIG. 2 displays white.

Next, the case of displaying black at the intersection pixel between the common electrode and the segment electrode of the bistable liquid crystal display panel 1 is described. The voltage waveform of the selection signal applied to the common terminal illustrated in part (d) of FIG. 2 is identical to the waveform illustrated in part (a) of FIG. 2.

As illustrated in part (e) of FIG. 2, the voltage waveform of the black write signal is a waveform which has the level of 0 for the first time interval “a” to the time interval “c” of the selection period T, the negative level −v for the subsequent time interval “d”, and the level of 0 for the remaining time intervals “e” to “g”

When such time-varying selection signal and time-varying black write signal as described above are applied, the waveform of the black display voltage, which is a voltage difference between the common terminal and the segment terminal, becomes a time-varying waveform. That is, as illustrated in part (f) of FIG. 2, the waveform of the black display voltage is a waveform which has the level of 0 for the first time interval “a” of the selection period T, the negative level −V for the subsequent time intervals “b” and “c”, a positive level +(V+v) for the subsequent time interval “d”, the positive level +V for the subsequent time interval “e”, the positive level +V−v for the subsequent time interval “f”, and the level of 0 for the remaining time interval “g” . This way, the black display voltage shows a voltage transition between −V and +(V+v).

The reason why the black display voltage having such waveform as described above is applied to the nematic liquid crystal is as follows. First, a stable state of orientation of nematic liquid crystal molecules is broken by the voltage having the negative level −V to raise the nematic liquid crystal molecules in the longitudinal direction (see part (i) of FIG. 2). After that, the positive level +(V+v) is reduced in stages so that the positive level +(V+v) is reduced to the positive level +V, the positive level +V is reduced to the positive level +V−v, and at the end, the positive level +V−v is reduced to the level of 0 so as to align the nematic liquid crystal molecules in substantially parallel (see part (j) of FIG. 2), to thereby set the uniform state (Uniform). This way, the intersection pixel of the bistable liquid crystal display panel applied with the black display voltage having the waveform illustrated in part (f) of FIG. 2 displays black.

FIG. 3 illustrates exemplary voltage waveforms applied to the common terminals and the segment terminal of the bistable liquid crystal display panel. Part (h) of FIG. 3 schematically illustrates a part of the bistable liquid crystal display panel composed of common terminals in three successive rows, that is, an n-th row common terminal COM [n], an (n+1) th row common terminal COM [n+1], and an (n+2)th row common terminal COM [n+2], and segment terminals in three columns intersecting the three rows, that is, an m-th column segment terminal SEG[m], an (m+1)th column segment terminal SEG[m+1], and an (m+2)th column segment terminal SEG [m+2].

Further, parts (a) to (g) of FIG. 3 illustrate voltage waveforms with the passage of time applied to the common terminals COM[n], COM[n+1], and COM[n+2] in the three successive rows and to the m-th column segment terminal SEG [m] intersecting the common terminals of the bistable liquid crystal display panel. Note that, portions encircled by the broken lines are voltage waveforms of selection signals.

A voltage waveform of the selection signal applied to each of the common terminals at the time of selection (Scan) is, as illustrated in each of parts (a) to (c) of FIG. 3, a waveform which has the level of 0 for the first time interval “a” of the selection period T, a positive level +V2 for the subsequent time interval “b”, the level of 0 for subsequent time intervals “c” and “d”, a positive level +V3 for the subsequent time interval “e”, and the level of 0 for the remaining time interval “f”. Note that, V3>V2.

A voltage waveform of a non-selection signal applied to each of the common terminals at the time of non-selection is, as illustrated in each of parts (a) to (c) of FIG. 3, a waveform which has the level of 0 for the first time interval “a” and the time interval “b” of the selection period T, the positive level +V2 for the subsequent time intervals “c” to “e”, and the level of 0 for the remaining time interval “f”.

The voltage waveform of the signal applied to the common terminal is significantly different between FIGS. 2 and 3. That is, the voltage waveform Scan of the selection signal illustrated in FIG. 2 is a voltage waveform showing a significant change to the positive and negative, but the voltage waveform No-Scan of the selection signal illustrated in FIG. 3 is a waveform showing a significant change to only the positive side. Note that, the non-selection signal illustrated in FIG. 3 also has a waveform showing a significant change to only the positive side.

As illustrated in part (a) of FIG. 3, the n-th row common terminal COM[n] is applied with the selection signal for a scan time section t1 and the non-selection signals for scan time sections t2 and t3. As illustrated in part (b) of FIG. 3, the subsequent (n+1)th row common terminal COM[n+1] is applied with the non-selection signal for the scan time section t1, the selection signal for the scan time section t2, and the non-selection signal for the scan time section t3. As illustrated in part (c) of FIG. 3, the subsequent (n+2)th row common terminal COM[n+2] is applied with the non-selection signals for the scan time sections t1 and t2 and the selection signal for the scan time section t3.

Voltage waveforms of segment voltages applied to the segment terminals, that is, the white write signal and the black write signal, are illustrated in part (d) of FIG. 3. In this case, the white write signal is applied for the scan time section t1, the black write signal is applied for the scan time section t2, and the white write signal is applied for the scan time section t3.

The voltage waveform of the white write signal is a waveform which has the level of 0 for the first time interval “a” and the time interval “b” of the selection period T, the positive level +V2 for the subsequent time intervals “c” and “d”, a positive level +V1 for the subsequent time interval “e”, and the level of 0 for the remaining time interval “f”.

Further, the voltage waveform of the black write signal is a waveform which has the level of 0 for the first time interval “a” and the time interval “b” of the selection period T, the positive level +V1 for the subsequent time interval “c”, the positive level +V2 for the subsequent time intervals “d” and “e”, and the level of 0 for the remaining time interval “f”.

When the selection signal or the non-selection signal is applied to the common terminals and the white write signal or the black write signal is applied to the segment terminal as described above, common-segment voltages between the common terminals and the segment terminal, that is, the white display voltage and the black display voltage, as illustrated in parts (e) to (g) of FIG. 3, are obtained.

That is, as illustrated in part (e) of FIG. 3, an intersection pixel between the n-th row common terminal COM[n] and the m-th column segment terminal SEG[m] in the scan time section t1 is applied with a white display voltage of a waveform which has the level of 0 for the first time interval “a” of the selection period T, the positive level +V2 for the subsequent time interval “b”, a negative level −V2 for the subsequent time intervals “c” and “d”, a negative level −V3 for the subsequent time interval “e”, and the level of 0 for the remaining time interval “f”.

In the scan time section t2, the intersection pixel is applied with a first parasite signal of a voltage waveform which has the level of 0 for the first time intervals “a” and “b” of the selection period T, a negative level −V4 for the subsequent time interval “c”, and the level of 0 for the remaining time intervals “d” to “f”. Further, in the scan time section t3, the intersection pixel is applied with a second parasite signal of a voltage waveform which has the level of 0 for the first time intervals “a” to “d” of the selection period T, the negative level −V4 for the subsequent time interval “e”, and the level of 0 for the remaining time interval “f”.

Next, as illustrated in part (f) of FIG. 3, an intersection pixel between the (n+1)th row common terminal CO[n+1] and the m-th column segment terminal SEG[m] is applied with the second parasite signal in the scan time section t1, a black display voltage in the scan time section t2, and the first parasite signal in the scan time section t3. The black display voltage is a voltage of a waveform which has the level of 0 for the first time interval “a” of the selection period T, the positive level +V2 for the subsequent time interval “b”, the negative level −V1 for the subsequent time interval “c”, the negative level −V2 for the subsequent time interval “d”, a negative level −V3 for the subsequent time interval “e”, and the level of 0 for the remaining time interval “f”.

Further, as illustrated in part (g) of FIG. 3, an intersection pixel between the (n+2) th row common terminal COM [n+2] and the m-th column segment terminal SEG[m] is applied with the first parasite signal in the scan time section t1, the second parasite signal in the scan time section t2, and the white display voltage in the scan time section t3.

As described above, with regard to display on the bistable liquid crystal display panel, black/white for one line is determined by a signal state of one common which outputs a voltage waveform of a selection signal and signal states of all the segments, and by sequentially scanning all the commons for one frame, display for the whole frame is determined. Only one common of the whole frame is scanned at a moment, and the remaining majority of commons output a voltage waveform of a non-selection signal. When the amount of charges to be charged or discharged in the bistable liquid crystal display panel is considered, it is necessary to focus on a potential difference between the voltage of the non-selection signal, which is output by the majority of the commons, and the voltage of the white write signal or the black write signal applied to the segment terminals. More specifically, the parasite signal in the waveform of the common-segment voltage between the common terminal and the segment terminal greatly contributes to the amount of charges to be charged or discharged in driving the bistable liquid crystal display panel, and thereby affects the amount of current consumption.

FIG. 4 illustrates waveforms in a specific driving mode (Mode-C) of the bistable liquid crystal display panel. Four kinds of waveforms applied to the bistable liquid crystal display panel are: the selection signal applied to the common terminal at the time of selection; the non-selection signal applied to the common terminal at the time of non-selection; the white write signal applied to the segment terminal; and the black write signal applied to the segment terminal. Their voltage waveforms are the same as those illustrated in FIG. 3.

Parts (a) to (c) of FIG. 4 also illustrate four kinds of voltages applied to the intersection pixel between the common terminal and the segment terminal, that is, the white display voltage, the black display voltage, the first parasite signal, and the second parasite signal. Their voltage waveforms are the same as those illustrated in FIG. 3.

Numerals “1” and “0” illustrated in part (d) of FIG. 4 indicate control signals for the waveform of a common voltage applied to the common terminal and the waveform of a segment voltage applied to the segment terminal. The waveform of the common voltage is controlled based on four signals CCX, C-Data, FR, and DispOffx. The waveform of the segment voltage is controlled based on three signals S-Data, FR, and DispOffx. When a driver (not employing SA driving system) which is already commercially available and normally drives a general STN liquid crystal is used as a segment driving device, the output voltage is controlled by the three control signals based on an input/output table of a segment driver (SEG-Drv.) shown in FIG. 5. Hence, the correspondences between the segment control signals and the segment voltage waveforms illustrated in FIG. 4 are established.

The waveform of a common voltage for driving the bistable liquid crystal display panel has the potential VCX, which does not appear during normal driving for the general STN liquid crystal, and hence a control signal for outputting the potential is expressed by CCX. When common output control is performed as shown in the column of the driving mode (Mode-C) in an input/output table of a common driver (COM-Drv.) shown in FIG. 6, the correspondences between the common control signals and the common voltage waveforms illustrated in FIG. 4 are established.

After the image is written into the bistable liquid crystal display panel in the manner described above, even if the common voltage and the segment voltage are set to GND to put the bistable liquid crystal display panel in a non-application state, the written display image is held. That is, even when power supply is turned off after image writing, the image on the bistable liquid crystal display panel is displayed. Power is necessary for writing, but display after the writing can be performed with no power. This is the feature of the bistable liquid crystal display panel.

Performing flashing display using the bistable liquid crystal display panel requires switching between a frame to be displayed and an all-white or all-black frame at a given time interval.

It is necessary to repeat, at a given time interval, the operation of overwriting to an image to be displayed and thereafter overwriting an all-black or all-white image at a given time interval similarly. For example, flashing at 1 Hz is realized by overwriting the frames of the bistable liquid crystal display panel every 1 second. Therefore, power is consumed every overwriting. Besides, overwriting requires high voltage and has large power consumption.

In addition, the bistable liquid crystal display panel has a problem that overwriting at low temperature takes time and hence flashing cannot be perceived by the above-mentioned method. Further, at room temperature, scanning is visually recognized.

### CITATION LIST

### Patent Literature

[PTL 1] JP 2004-4552 A

### SUMMARY OF INVENTION

### Technical Problem

The problem to be solved by the present invention is to reduce power consumption in a method and a device for driving a dot matrix display panel using bistable nematic liquid crystal, while attaining stable flashing display covering from low temperature to high temperature.

### Solution to Problem

In order to solve the above-mentioned problem, an image to be displayed is first written into the bistable liquid crystal display panel by the above-mentioned method. Next, when a waveform of low voltage at low frequency is applied to the whole surface of the bistable liquid crystal display panel, the liquid crystal molecules are inclined to some extent, if not to the state vertical to a substrate, and the frame displays an intermediate color of gray close to white. After that, when the voltage application is stopped, the image displayed before the application appears because the orientation state of the bistable liquid crystal display panel 1 is not broken. By utilizing this phenomenon, in addition to realizing the gray display, a state of applying the waveform of low voltage at low frequency and a non-application state were repeated at a given time interval, to thereby perform flashing. Further, by applying the waveform of low voltage at low frequency to a part of the bistable liquid crystal display panel rather than the entire frame, partial flashing display was able to be performed. In addition, by turning ON the power supply circuit only when each voltage level changed, power consumption was able to be reduced as well.

### Advantageous Effects of Invention

According to the present invention, in the method of driving a dot matrix display panel using bistable nematic liquid crystal, flashing display in which the whole frame was switched at a time was able to be realized. Further, according to the present invention, in the device for driving a dot matrix display panel using bistable nematic liquid crystal, without greatly changing a conventional device for driving a dot matrix display panel using bistable nematic liquid crystal, the device for driving a dot matrix display panel using bistable nematic liquid crystal capable of driving gray display of an intermediate color of gray and flashing display at low power consumption was able to be provided.

### BRIEF DESCRIPTION OF DRAWINGS

FIG. 1 is a general functional block diagram illustrating display control of a bistable liquid crystal display panel.

FIG. 2 is an explanatory diagram of switching of bistable liquid crystal, schematically illustrating how an intersection pixel displays white or black in response to respective waveforms of voltages applied to a common terminal and a segment terminal and a waveform of a common-segment voltage.

FIG. 3 illustrates respective waveforms of voltages applied to the common terminal and the segment terminal and a waveform of the common-segment voltage of the bistable liquid crystal display panel.

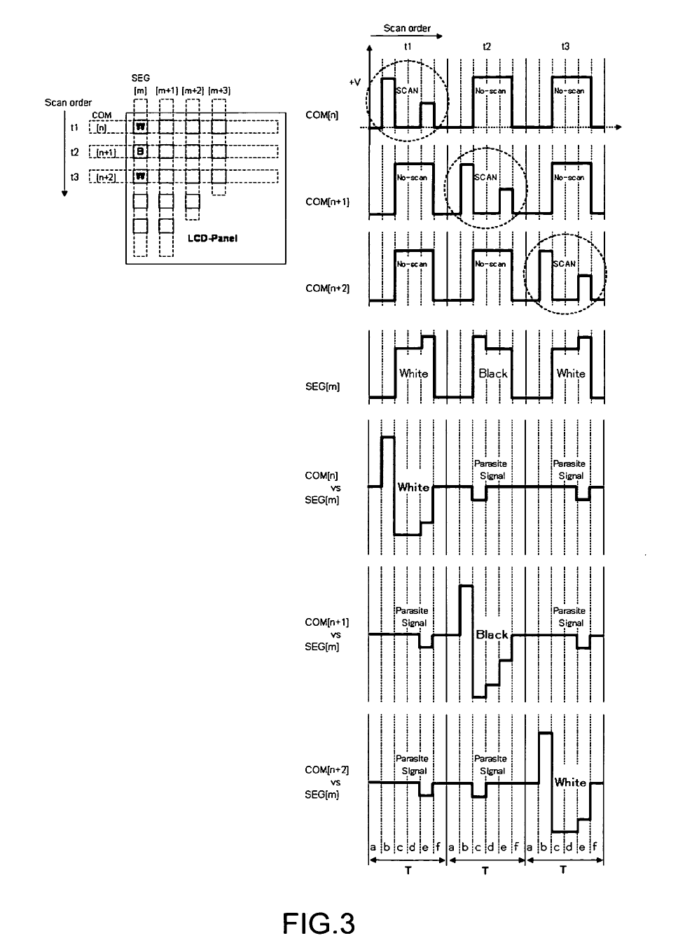

FIG. 4 illustrates a method of driving a dot matrix display panel using bistable nematic liquid crystal, illustrating waveforms of a common voltage, a segment voltage, and a common-segment voltage in a driving mode (Mode-C).

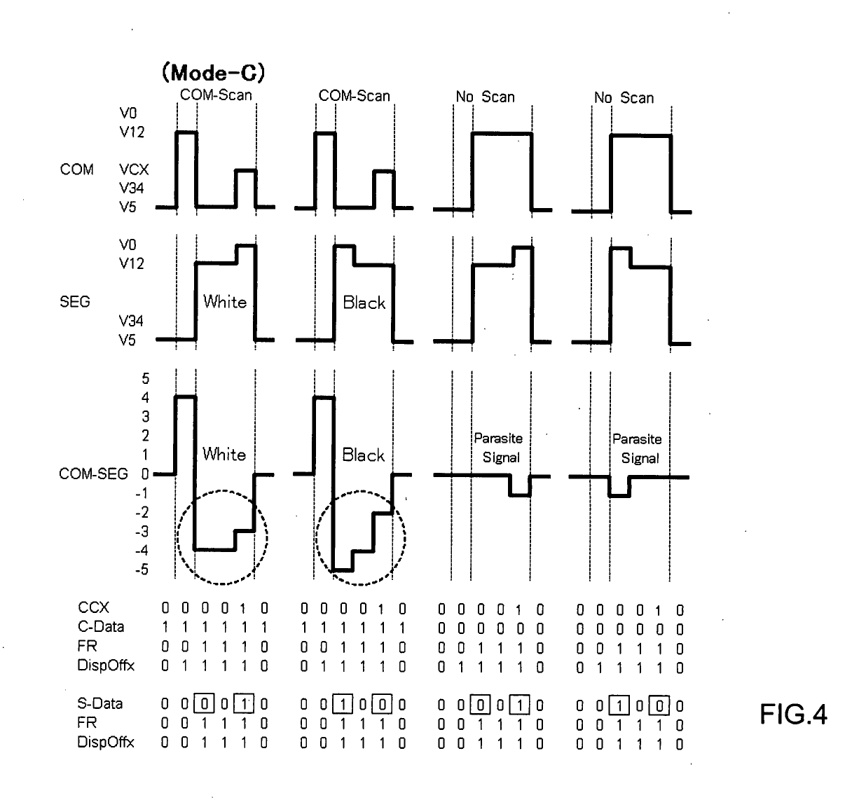

FIG. 5 is a truth table showing an input/output table of a segment driver (SEG-Drv.).

FIG. 6 is a truth table showing an input/output table of a common driver (COM-Drv.).

FIG. 7 illustrates waveforms of the common voltage, the segment voltage, and the common-segment voltage in a bistable liquid crystal display panel according to Example 1 of the present invention.

FIG. 8 illustrates waveforms of the common-segment voltage applied to liquid crystal molecules of the bistable liquid crystal display panels according to Examples 1, 2, and 3 of the present invention.

FIG. 9 illustrates waveforms of the common voltage, the segment voltage, and the common-segment voltage in the bistable liquid crystal display panel according to Example 2 of the present invention.

FIG. 10 illustrates waveforms of the common voltage, the segment voltage, and the common-segment voltage in the bistable liquid crystal display panel according to Example 3 of the present invention.

### DESCRIPTION OF EMBODIMENT

A flashing display method for a bistable liquid crystal display panel according to the present invention may be implemented by changing a driving waveform without changing hardware of a device for driving a bistable liquid crystal display panel.

### EXAMPLE 1

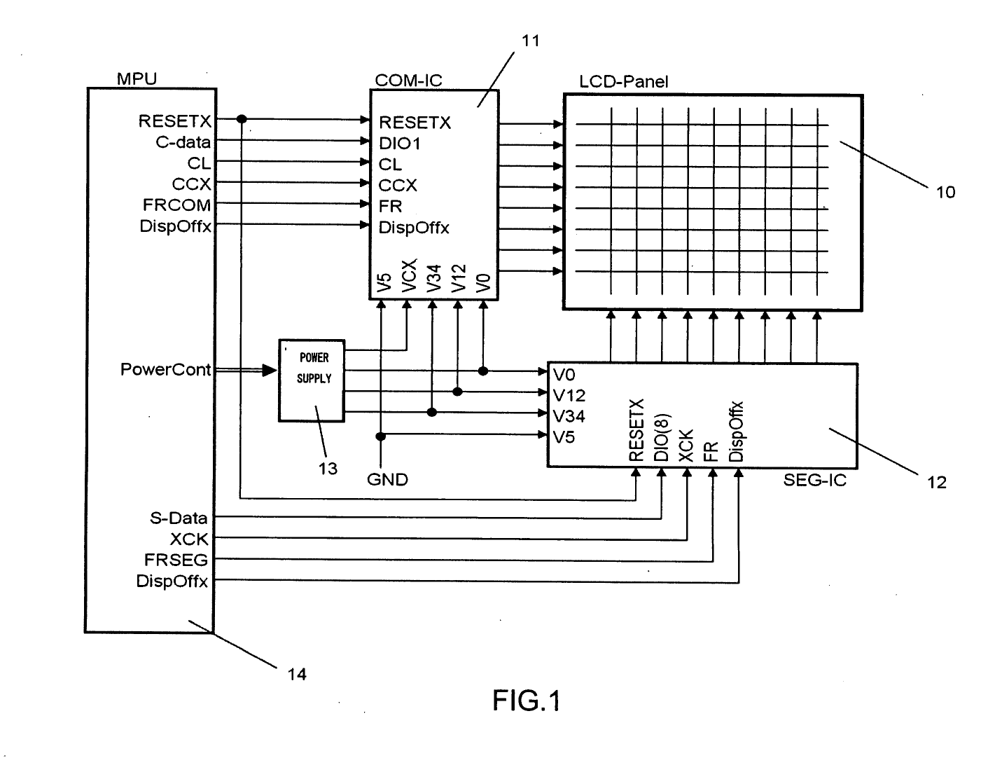

The driving device to which a driving method according to the present invention is applied, that is, a driving device for a dot matrix display panel using bistable nematic liquid crystal, which is capable of selecting black/white only by positive polarity driving or negative polarity driving, has the same hardware configuration as a conventional one. That is, as illustrated in FIG. 1, the bistable liquid crystal display panel 10 is driven by the driving device including the common driving section (COM-IC) 11 for driving common lines in the horizontal direction, the segment driving section (SEG-IC) 12 for driving segment lines in the vertical direction, the power supply circuit 13 for generating drive potentials (V0, V12, V34, V5, and VCX), and the control section (MPU) 14 for controlling the common driving section 11, the segment driving section 12, and the power supply circuit 13.

The signals and functions of the control section 14 for controlling the common driving section 11 and the segment driving section 12 are the same as those in a normal STN driver circuit. For the common driving section 11, there are prepared the initialization signal RESETX, the COM-Data for determining scan timing, the writing clock CL, the alternating current signal FRCOM, and DispOffx for display erasing. For the segment driving section 12, there are prepared the initialization signal RESETX, DIO(8) for providing the display image data, the writing clock XCK, the alternating current signal FRSEG, and DispOffx for display erasing are set. As a matter of course, the power supply circuit 13 may be incorporated in the common driving section (COM-IC) 11 or the segment driving section (SEG-IC) 12 may be further incorporated therein, to thereby serve as a single IC.

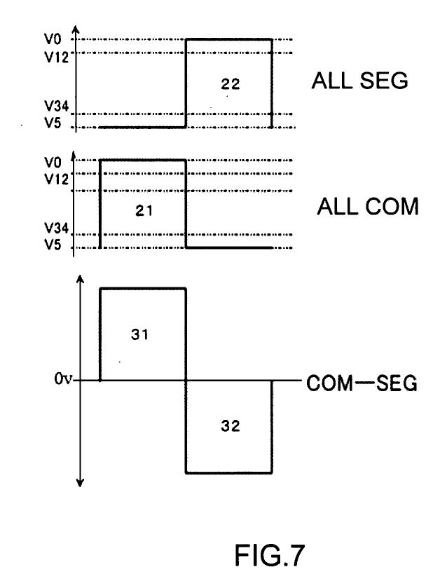

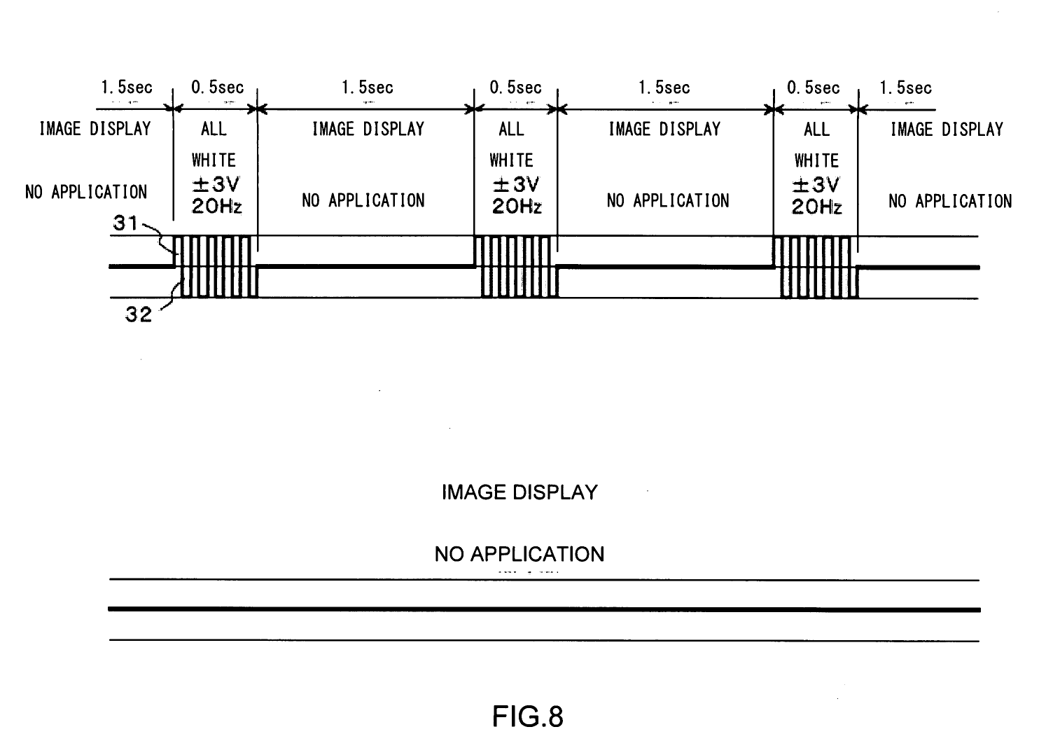

First, an image is written in advance into the bistable liquid crystal display panel by using a conventional driving method, and thereafter power is turned off to put the bistable liquid crystal display panel in a holding state. Next, referring to FIGS. 7 and 8, a flashing driving method for a dot matrix display panel using bistable nematic liquid crystal is described.

FIG. 7 illustrates voltage waveforms for when the whole frame of the dot matrix display panel using bistable nematic liquid crystal, which is capable of selecting black/white only by positive polarity driving or negative polarity driving, is subjected to flashing driving, in which part (a) of FIG. 7 illustrates a signal 22 applied to all segment terminals, part (b) of FIG. 7 illustrates a signal 21 applied to all common terminals, and part (c) of FIG. 7 illustrates voltage waveforms 32 and 31 corresponding to a common-segment voltage. In FIG. 7, the horizontal axis represents time, which is composed of two time sections, the former half and the latter half. All the segment signals have a voltage V5 in the first time section, that is, the former time section. In the latter time section, the voltage changes to a voltage V0 in the latter time section as indicated by the signal 22. Further, all the common terminals have the voltage V0 in the former time section as indicated by the signal 21 and have the voltage V5 in the latter time section. The common-segment voltage represents a voltage waveform obtained by subtracting all the common signals from the segment signal. Specifically, the voltage becomes V0 in the former time section and −V0 in the latter time section.

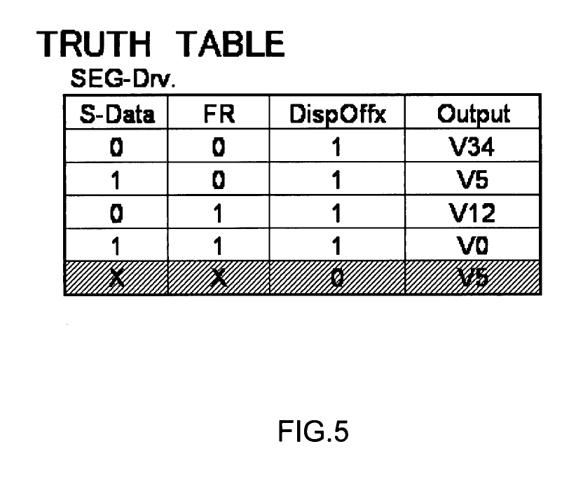

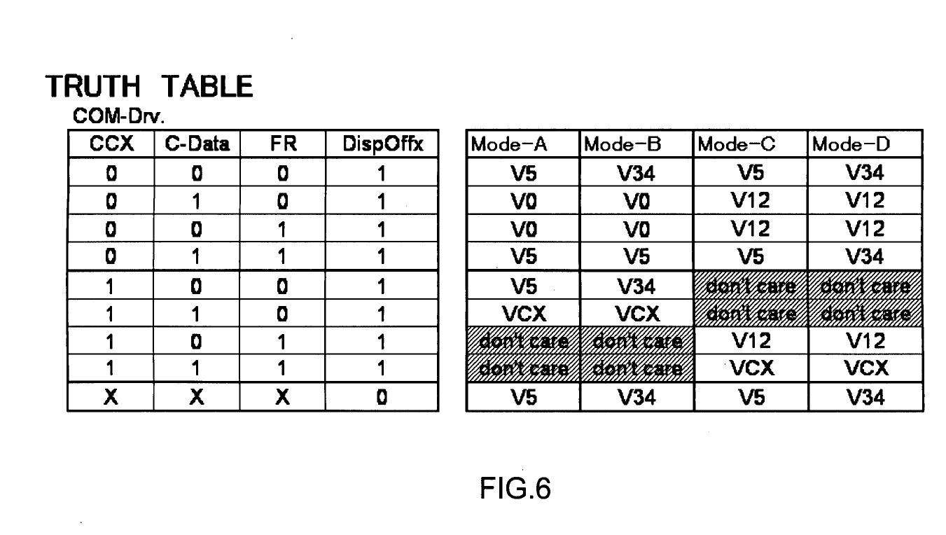

The waveform for all the segments is realized, according to the truth table of FIG. 5, by the repetition of S-data=1, FR=0, and Dispoff=1 and S-data=1, FR=1, and Dispoff=1. The waveform for all the commons is realized, according to the truth table of FIG. 6, by the repetition of CCX=0, C-data=0, FR=1, and Dispoff=1 and CCX=0, C-data=0, FR=0, and Dispoff=1. By repeating this rectangular wave and the non-application state, flashing display was performed. Part (a) of FIG. 8 illustrates a waveform for flashing display at a 2-second interval performed by repeating this rectangular wave for 0.5 second and the non-application state for 1.5 seconds. The voltage of 3 V having the frequency of 20 Hz was used. Part (b) of FIG. 8 illustrates the waveform for all SEG in the state in which the application has ended. The waveform shows no change and continues to maintain a constant value all the time.

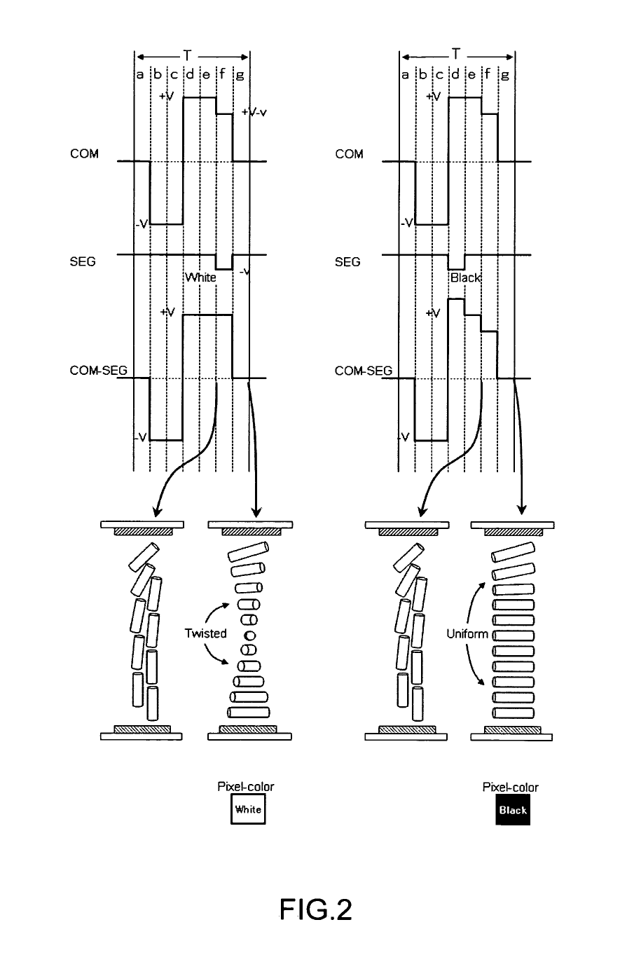

Generally, the waveform for overwriting is such a waveform as illustrated in FIG. 2 that high voltage (20 V or higher) is applied to break down a stable state of orientation of nematic liquid crystal molecules so as to raise the nematic liquid crystal molecules in the longitudinal direction (see part (g) of FIG. 2), and thereafter the voltage is reduced abruptly or in stages to write the image. However, the voltage of the waveform of the present invention is 3 V, which is not enough to break down the stable state of orientation of nematic liquid crystal molecules but to raise the nematic liquid crystal molecules in the longitudinal direction to some extent. In this state, the nematic liquid crystal molecules are oriented in the longitudinal direction, resulting in grayish-white display on the whole frame.

Next, when the application of voltage is stopped, the image displayed before the application appears because the stable state of orientation of nematic liquid crystal molecules is not broken down. By repeating those two states, flashing display was realized.

It is preferred that the voltage fall within the range of from 1 to 5 V. Further, the frequency for driving in the case of a general STN liquid crystal is 60 Hz, but in the present invention, it is preferred that the range of the frequency be from 10 Hz to 20 Hz. Power consumption was able to be significantly reduced by the use of low voltage and low frequency and full-screen driving with no data writing. Besides, in order to suppress power consumption, the power supply for AMP was interrupted in the non-application state and also the AMP was stopped even at a time other than when the waveform during the application showed a change. Therefore, average power consumption was able to be reduced to about 200 μW.

### EXAMPLE 2

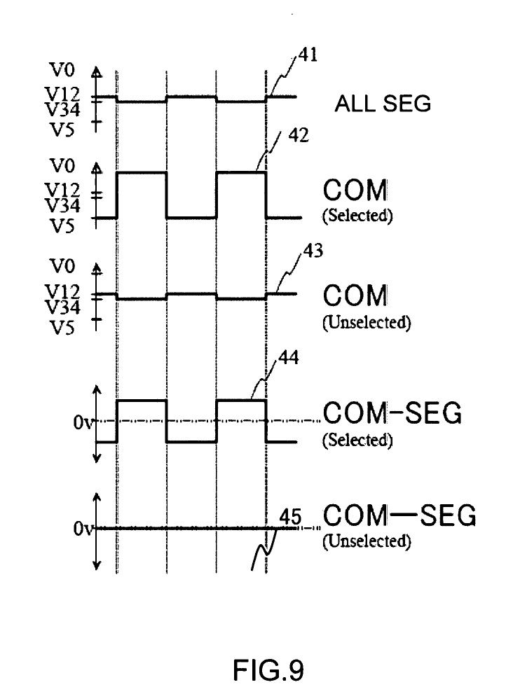

Similarly to Example 1, an image is written in advance into the bistable liquid crystal display panel by using a conventional driving method, and thereafter power is turned off to put the bistable liquid crystal display panel in a holding state. Next, referring to FIGS. 9 and 8, a flashing driving method for a dot matrix display panel using bistable nematic liquid crystal is described.

FIG. 9 illustrates voltage waveforms for when a horizontal part of the dot matrix display panel using bistable nematic liquid crystal, which is capable of selecting black/white only by positive polarity driving or negative polarity driving, is subjected to flashing driving, in which part (a) of FIG. 9 illustrates a signal 41 applied to all the segment terminals, part (b) of FIG. 9 illustrates a signal 42 applied to a selected common terminal, part (c) of FIG. 9 illustrates a signal 43 applied to an unselected common terminal, part (d) of the figure illustrates a voltage waveform 44 of a common-segment voltage for a portion which is in a selected state and flashes, and part (e) of the figure illustrates a voltage waveform 45 of a common-segment voltage for a portion which is in the unselected state and does not flash.

The waveform for all the segments is realized, according to the truth table of FIG. 5, by the repetition of S-data=0, FR=1, and Dispoff=1 and S-data=0, FR=0, and Dispoff=1 . Further, if the voltage levels of V12 and V34 are set to the same ½ of V0, it is not necessary to produce the segment waveform as well.

Before the start of flashing, the common waveform is divided in advance into the selected portion (C-data=1) and the unselected portion (C-data=0) by DIO and CL under no application of voltage. Specifically, DIO is set to 1 and CL clocks corresponding to the number of lines of portions to be flashed are supplied to produce the selected portion, and thereafter DIO is set to 0 and the CL clocks are used for shift to a predetermined position. This way, the selected portion (C-data=1) and the unselected portion (C-data=0) are each set to have a predetermined width at a predetermined position.

Then, according to the truth table of FIG. 6, by repeating CCX=0, FR=0, and Dispoff=1 in Mode-B and CCX=0, FR=1, and Dispoff=1 in Mode-C, the signal 42 and the signal 43 in the selected portion and the unselected portion of FIG. 9 are realized, respectively.

Using those waveforms, the application state for 0.5 second and the non-application state for 1.5 seconds are repeated similarly to Example 1. Then, a portion selected by the common driver has the waveform of part (d) of FIG. 9 and an unselected portion is always in the non-application state as illustrated in part (e) of FIG. 9. Therefore, the portion selected by the common driver can perform flashing display at intervals of two seconds, and the unselected portion can perform display without flashing.

### EXAMPLE 3

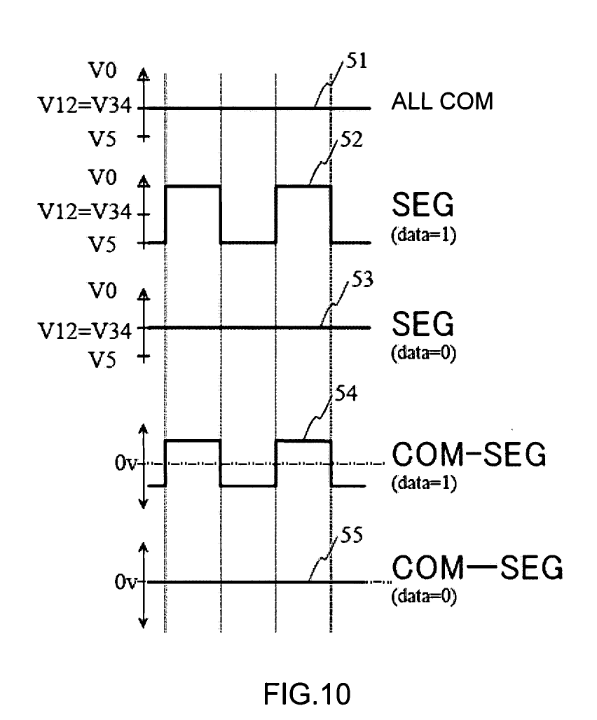

Similarly to Example 1, an image is written in advance into the bistable liquid crystal display panel by using a conventional driving method, and thereafter power is turned off to put the bistable liquid crystal display panel in a holding state. Next, referring to FIGS. 10 and 8, a flashing driving method for a dot matrix display panel using bistable nematic liquid crystal is described.

FIG. 10 illustrates voltage waveforms for when a vertical part of the dot matrix display panel using bistable nematic liquid crystal, which is capable of selecting black/white only by positive polarity driving or negative polarity driving, is subjected to flashing driving, in which part (a) of FIG. 10 illustrates a signal 51 applied to all the common terminals, part (b) of FIG. 10 illustrates a signal 52 applied to a segment terminal to be flashed, part (c) of FIG. 10 illustrates a signal 53 applied to a segment terminal not to be flashed, part (d) of FIG. 10 illustrates a voltage waveform 54 of a common-segment voltage for a portion to be flashed, and part (e) of FIG. 10 illustrates a voltage waveform 55 of a common-segment voltage for a portion not to be flashed.

The waveform for all the commons may be selected from one of the voltage levels V12 and V34 whose values are set to ½ of V0. According to the truth table of FIG. 6, a combination of CCX=0, C-data=0, FR=0, and Dispoff=1 in Mode-B indicates the voltage level of V34.

As to the segment waveform, a portion to be flashed and a portion not to be flashed are written in the segment driver in advance immediately before the start of flashing. The portion to be flashed corresponds to S-data=1, and the portion not to be flashed corresponds to S-data=0. Next, in the case of FR=0 under Dispoff=1, the voltage V5 is output to the portion to be flashed and the voltage V34 is output to the portion not to be flashed, whereas in the case of FR=1 under FR=1, the voltage V0 is output to the portion to be flashed and the voltage V12 is output to the portion not to be flashed. Here, the voltages V12 and V34 have the same voltage level, and hence the voltage waveform 54, which is a rectangular wave for the portion to be flashed, is applied to the portion to be flashed (data=1), whereas the portion not to be flashed (data=0) is put in a non-application state.

Using those waveforms, the application state for 0.5 second and the non-application state for 1.5 seconds are repeated similarly to Example 1. Then, the portion for which data=1 is written in the segment driver has the waveform of part (d) of FIG. 10 and the portion for which data=0 is written therein is always in the non-application state as illustrated in part (e) of FIG. 10. Therefore, the portion for which data=1 is written in the segment driver can perform flashing display at intervals of two seconds, and the portion for which data=0 is written therein can perform display without flashing.

The waveforms in each of Examples are all rectangular waves, but it should be understood that similar effects can be obtained even if the voltage levels of V0 and V5 are varied to provide another waveform such as a sine wave, because the voltage levels are not so high to break down a stable state of orientation of nematic liquid crystal molecules but to raise the nematic liquid crystal molecules in the longitudinal direction to some extent.

According to the present invention, in the method of driving a dot matrix display panel using bistable nematic liquid crystal, flashing display in which the whole or part of the frames are switched at a time can be realized. Further, according to the present invention, in the device for driving a dot matrix display panel using bistable nematic liquid crystal, without greatly changing a conventional device for driving a dot matrix display panel using bistable nematic liquid crystal, it is possible to provide the device for driving a dot matrix display panel using bistable nematic liquid crystal capable of driving flashing display at low power consumption.

In the present invention, the state for white (White) is called Twisted and the state for black (Black) is called Uniform for convenience sake. Actually, however, it should be also possible to produce the state of Uniform for white (White) and the state of Twisted for black (Black) by changing the angle of polarizing films of the bistable liquid crystal display panel. Further, the display is not limited to white and black display, and may be one relating to color display. In the description of the present invention, the terms “white” and “black” are used merely for facilitating the understanding, and similarly the expression “gray” is used merely for convenience sake as an intermediate color of the above-mentioned two kinds of colors. It should be noted that the above-mentioned expressions are not intended to limit the scope of claims.

In the present invention, it is preferred to apply such a voltage that does not break down a stable state of orientation of nematic liquid crystal molecules. Specifically, it is preferred that the voltage fall within the range of from 1 to 5 V. Further, the frequency for driving in the case of a general STN liquid crystal is 60 Hz, but in the present invention, it is preferred that the range of the frequency be from 10 Hz to 20 Hz. Further, the purpose of decreasing the frequency is to reduce power consumption. Accordingly, to realize gray display and flashing display described in the present invention, it is not always necessary to perform driving in the above-mentioned frequency range.

Further, the above description in the present invention is about bistable nematic liquid crystal, but this is merely an example. It should be understood that the present invention is not limited to bistable nematic liquid crystal as long as the material has two stable states.

Note that, in the present invention, the common lines and the segment lines are formed on the bistable liquid crystal display panel so as to be substantially orthogonal to each other. However, the common lines and the segment lines are not necessarily orthogonal to each other, and are only necessary to intersect each other. For example, it is conceivable to form the common lines and the segment lines to be parabolic, exemplified by polar coordinates.

Further, which of the positive polarity driving and the negative polarity driving is performed is determined by a common-segment voltage waveform. In the positive polarity driving, a white or black state is written at a potential on the positive side. In the negative polarity driving, a white or black state is written at a potential on the negative side. In gray display and flashing display of the present invention, the effects of the present invention can be expected by the same method irrespective of the positive polarity driving or the negative polarity driving.

### INDUSTRIAL APPLICABILITY

The present invention can be utilized as a liquid crystal display device which is capable of long-term driving by simplified power supply from a battery or the like, and is applicable to various purposes, including electronic shelf label and product advertisement.

### REFERENCE SIGNS LIST

10 bistable liquid crystal display panel
11 common driving section (COM-IC)
12 segment driving section (SEG-IC)
13 power supply circuit
14 control section (MPU)
21 signal applied to all common terminals
22 signal applied to all segment terminals
31 common-segment voltage waveform
32 common-segment voltage waveform
41 signal applied to all segment terminals
42 signal applied to selected common terminal
43 signal applied to unselected common terminal
44 voltage waveform for portion to be flashed
45 voltage waveform for portion not to be flashed
51 signal applied to all common terminals
52 signal applied to segment terminal to be flashed
53 signal applied to segment terminal not to be flashed
54 voltage waveform for portion to be flashed
55 voltage waveform for portion not to be flashed
COM common signal
COM-Scan selection signal
COM-No Scan non-selection signal
SEG segment signal
COM-SEG common-segment voltage

1. A method of driving a dot matrix display panel using bistable nematic liquid crystal capable of operating by positive polarity driving or negative polarity driving, comprising applying a voltage waveform of from 1 to 5 V to a driving section of a bistable liquid crystal display panel.

2. A method of driving a dot matrix display panel using bistable nematic liquid crystal according to claim 1, wherein, before the applying a voltage waveform, an image is written into the bistable liquid crystal display panel.

3. A method of driving a dot matrix display panel using bistable nematic liquid crystal according to claim 1, wherein the voltage waveform has a frequency in a range of from 10 Hz to 20 Hz.

4. A method of driving a dot matrix display panel using bistable nematic liquid crystal according to claim 1, wherein the voltage waveform is applied to a whole frame of the bistable liquid crystal display panel.

5. A method of driving a dot matrix display panel using bistable nematic liquid crystal according to claim 1, further comprising repeating, at a given time interval, a state of applying the voltage waveform and a non-application state of applying no voltage waveform, to thereby perform flashing display.

6. A method of driving a dot matrix display panel using bistable nematic liquid crystal according to claim 5, wherein the voltage waveform is applied only to a selected common terminal.

7. A method of driving a dot matrix display panel using bistable nematic liquid crystal according to claim 5, wherein the voltage waveform is applied only to a selected segment terminal.

8. A method of driving a dot matrix display panel using bistable nematic liquid crystal according to claim 1, further comprising turning ON a power supply circuit for driving the bistable liquid crystal display panel only when a voltage level of the voltage waveform changes.

9. A device for driving a dot matrix display panel using bistable nematic liquid crystal capable of operating by positive polarity driving or negative polarity driving, the device comprising:
a bistable liquid crystal display panel including common lines and segment lines;
a common driving section for driving the common lines;
a segment driving section for driving the segment lines;
a power supply circuit for generating drive potentials; and
a control section for controlling the common driving section, the segment driving section, and the power supply circuit,
wherein the control section applies a voltage waveform of from 1 to 5 V to the common driving section or the segment driving section.

10. A device for driving a dot matrix display panel using bistable nematic liquid crystal according to claim 9, wherein, before the voltage waveform is applied to the bistable liquid crystal display panel, an image is written into the bistable liquid crystal display panel.

11. A device for driving a dot matrix display panel using bistable nematic liquid crystal according to claim 9, wherein the voltage waveform has a frequency in a range of from 10 Hz to 20 Hz.

12. A device for driving a dot matrix display panel using bistable nematic liquid crystal according to claim 9, wherein the voltage waveform is applied to all the common lines or all the segment lines.

13. A device for driving a dot matrix display panel using bistable nematic liquid crystal according to claim 9, wherein a state of applying the voltage waveform and a non-application state of applying no voltage waveform are repeated at a given time interval, to thereby perform flashing display.

14. A device for driving a dot matrix display panel using bistable nematic liquid crystal according to claim 13, wherein the voltage waveform is applied only to a selected common terminal.

15. A device for driving a dot matrix display panel using bistable nematic liquid crystal according to claim 13, wherein the voltage waveform is applied only to a selected segment terminal.

16. A device for driving a dot matrix display panel using bistable nematic liquid crystal according to claim 9, wherein the power supply circuit is turned ON only when a voltage level of the voltage waveform changes.

17. A device for driving a dot matrix display panel using bistable nematic liquid crystal according to claim 9, wherein the common lines and the segment lines are substantially orthogonal to each other.
